(19) United States
(12) Patent Application Publication
(10) Pub. No.: US 2023/0363353 A1
(43) Pub. Date: Nov. 16, 2023

(54) NOVEL RUNNING WHEEL DEVICE FOR HAMSTER

(71) Applicant: JIANJUN ZHENG, MIANYANG (CN)

(72) Inventor: JIANJUN ZHENG, MIANYANG (CN)

(21) Appl. No.: 17/663,013

(22) Filed: May 11, 2022

(51) Int. Cl. A01K 15/02

(52) U.S. Cl. CPC A01K 15/027

(57) ABSTRACT

The present invention discloses a novel running wheel device for the hamster. The novel running wheel device includes a bottom plate, a height and angle adjusting mechanism, a mounting shaft, a bearing, a running wheel mounting assembly and a running wheel body, wherein the running wheel mounting assembly includes a positioning member and a locking nut; the positioning member includes a limiting portion, a positioning portion and a cover body connecting portion; the positioning portion is inserted into a center hole in a back plate of the running wheel body; the locking nut is matched with a second outer thread of the cover body connecting portion through an inner thread, and thus mounted on the cover body connecting portion and located on the inner surface of the running wheel body; and the locking nut locks the running wheel body between the limiting portion and the locking nut.

### TECHNICAL FIELD

The present invention relates to the technical field of pet appliances, and more particularly, to a novel running wheel device for the hamster.

### BACKGROUND

Hamsters are a kind of small pets favored by people, and they have the nature of loving sports. A wild hamster needs to run 5 kilometers a day, and thus needs to be supplied with a sports mechanism for it to run while in rearing. A running wheel for hamsters is favored by the majority of hamster breeders because it occupies a small space and can meet the requirements for hamster movement. However, a running wheel body of the existing running wheel for hamsters is locked on a running wheel mounting assembly by at least two screws. When the running wheel body is disassembled or assembled, it is necessary to unscrew or tighten screws one by one, which makes the disassembly and assembly of the running wheel body very time-consuming, troublesome and inconvenient.

### SUMMARY

An objective of the present invention is to overcome the above defects of the prior art and provide a novel running wheel device for the hamster.

In order to fulfill said objective, the present invention provides a novel running wheel device for the hamster, including a bottom plate, a height and angle adjusting mechanism, a mounting shaft, a bearing, a running wheel mounting assembly and a running wheel body, wherein the height and angle adjusting mechanism is mounted on the bottom plate; one end of the mounting shaft is connected to the height and angle adjusting mechanism; the mounting shaft is arranged transversely; the bearing is mounted at the other end of the mounting shaft; the running wheel body is mounted on the bearing through the running wheel mounting assembly and can rotate around the mounting shaft;

the running wheel mounting assembly includes a positioning member and a locking nut, wherein the positioning member sleeves an outer ring of the bearing; the positioning member includes a limiting portion, a positioning portion and a cover body connecting portion, wherein the limiting portion is used to abut against the back surface of the running wheel body; the positioning portion is inserted into a center hole in a back plate of the running wheel body; the cover body connecting portion is used for mounting the locking nut; the limiting portion, the positioning portion and the cover body connecting portion are connected in sequence; the surface of one end of the cover body connecting portion away from the positioning portion is provided with a second outer thread; an inner wall of the center hole of the locking nut is provided with an inner thread; the positioning portion is inserted into the center hole in the back plate of the running wheel body; the limiting portion is located on the back of the running wheel body; the locking nut is matched with the second outer thread of the cover body connecting portion through the inner thread, and thus mounted on the cover body connecting portion and located on the inner surface of the running wheel body; and the locking nut locks the running wheel body between the limiting portion and the locking nut.

The height and angle adjusting mechanism comprises an erected mounting column, an adjusting sleeve and at least one first locking screw, wherein the mounting column is cylindrical, and the lower end of the mounting column is fixedly connected to the bottom plate; the adjusting sleeve rotatably and liftably sleeves the mounting column; a wall body of the adjusting sleeve is provided with at least one transverse first screw hole in a penetrating manner; and the first locking screws are respectively in threaded connection into the corresponding first screw holes and lock the outer wall of the mounting column, such that the adjusting sleeve locks the mounting column, and one end of the mounting shaft is connected to the adjusting sleeve.

An outer wall of one end of the mounting shaft is provided with a first outer thread; an outer side wall of the adjusting sleeve is concavely provided with a transverse first threaded hole; and one end of the mounting shaft is inserted into the first threaded hole of the adjusting sleeve and is in threaded connection to the first threaded hole, and thus connected to the adjusting sleeve.

Further comprising a second locking screw, wherein the outer side wall of the adjusting sleeve is concavely provided with a transverse insertion hole; one end of the adjusting sleeve is concavely provided with a longitudinal second threaded hole, wherein one end of the second threaded hole is communicated with the insertion hole; one end of the mounting shaft is inserted into the insertion hole of the adjusting sleeve; and the second locking screw is mounted in the second screw hole and locks the outer wall of one end of the mounting shaft, such that one end of the mounting shaft is fixedly inserted into the insertion hole.

The positioning portion is circular; the center hole in the back plate of the running wheel body is set to be a circular hole; and a positioning structure is arranged between the running wheel body and the positioning portion of the positioning member.

The positioning structure is provided with two first planes and two second planes, wherein the two first planes are symmetrically arranged on the outer side wall of the positioning portion; the two second planes are symmetrically arranged on the inner wall of the center hole in the back plate of the running wheel body; and the first planes are respectively in contact and cooperation with the respective second planes.

The bearing is provided as a ball bearing; the inner ring of the bearing and the mounting shaft are fixedly connected by means of interference fit; and a limiting protrusion is convexly arranged in the middle of the mounting shaft.

An end cover located inside the running wheel body is connected to the other end of the mounting shaft; the inner surface of the end cover is provided with a stud; and the stud is in threaded connection into the second threaded hole formed in the other end of the mounting shaft.

The inner side wall of the running wheel body is provided with an annular lining for increasing a friction force between the hamster and the running wheel body; the inner edge at an entry of the running wheel body is provided with an edge-biting prevention baffle ring for preventing the hamster from biting the edge of the annular lining; and the edge-biting prevention baffle ring is located on the side edge of the annular lining and covers the edge of the annular lining.

The annular lining is provided as a rubber pad.

Compared with the prior art, the present invention has the following technical effects.

1. The novel running wheel device of the present invention is simple and novel in structure and reasonable in design. The novel running wheel device is provided with the mounting shaft, the bearing, the running wheel mounting assembly, the running wheel body and the height and angle adjusting mechanism, which are used for the hamster to achieve a running purpose. In addition, the running wheel body is locked between the limiting portion of the positioning member and the locking nut through the locking nut. Therefore, compared to the traditional locking screw mounting manner, this mounting manner has the advantages of being convenient, simple and fast to disassemble and assemble.

2. According to the novel running wheel device of the present invention, the height and angle adjusting mechanism adjusts a height and angle of the running wheel body, and thus can meet the needs of a user to adjust the height and angle of the running wheel at the same time.

3. According to the novel running wheel device of the present invention, an edge-biting prevention baffle ring located on the side edge of an annular lining is arranged on the inner side edge at an entry of the running wheel body, and the edge-biting prevention baffle ring can block the edge of the annular lining, making it impossible for the hamster to bite.

### BRIEF DESCRIPTION OF DRAWINGS

FIG. 1 is a schematic structural diagram I of a novel running wheel device for the hamster.

FIG. 2 is a schematic structural diagram II of the novel running wheel device for the hamster.

FIG. 3 is a schematic structural diagram III of the novel running wheel device for the hamster.

FIG. 4 is a sectional view of the novel running wheel device for the hamster.

FIG. 5 is a half-section enlarged view of a mounting part of a running wheel body.

FIG. 6 is an assembly schematic diagram of a mounting shaft and an adjusting sleeve.

FIG. 7 is an assembly exploded view of the running wheel body and a running wheel mounting assembly.

FIG. 8 is a schematic structural diagram of a positioning member.

FIG. 9 is a half-section view of the positioning member.

FIG. 10 is a schematic structural diagram of the running wheel body.

FIG. 11 is an assembly schematic diagram of another mounting shaft and the adjusting sleeve.

FIG. 12 is a half-section view of another running wheel body.

FIG. 13 is an exploded view of another running wheel body.

### DETAILED DESCRIPTION

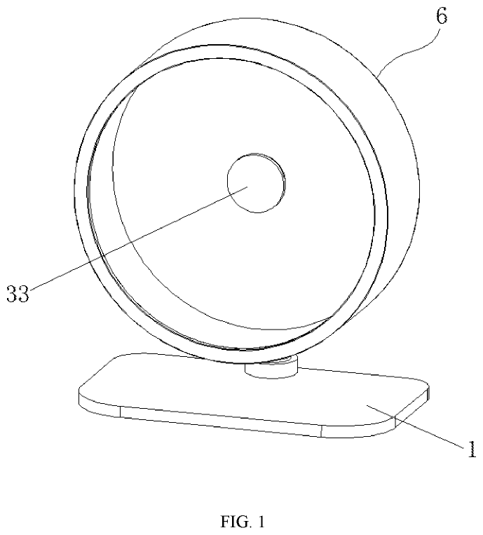

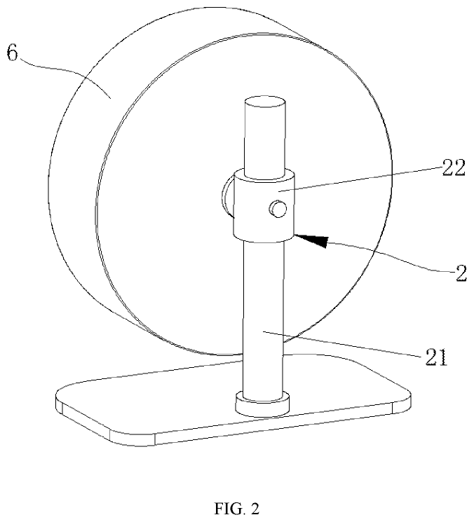

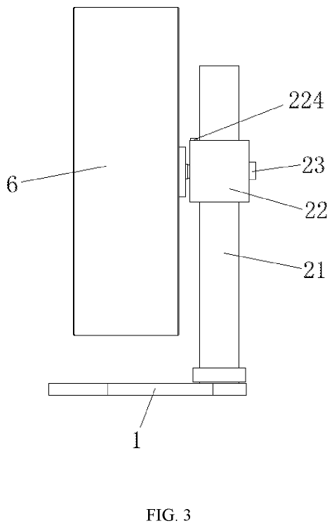

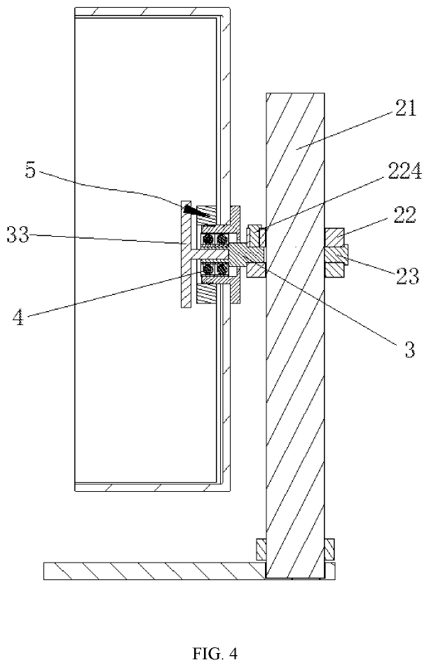

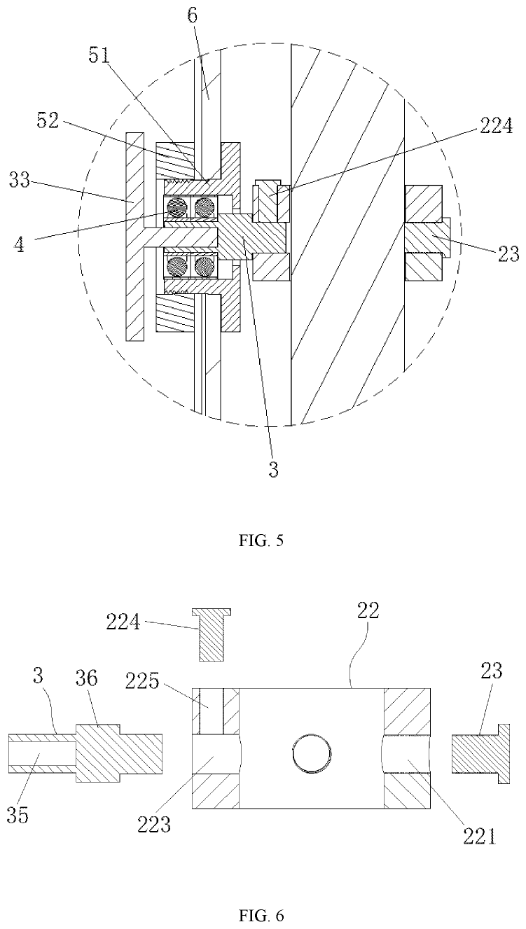

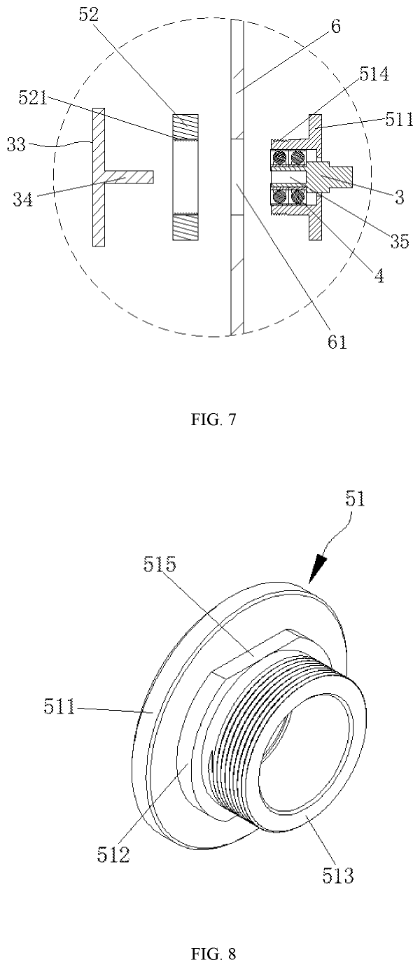

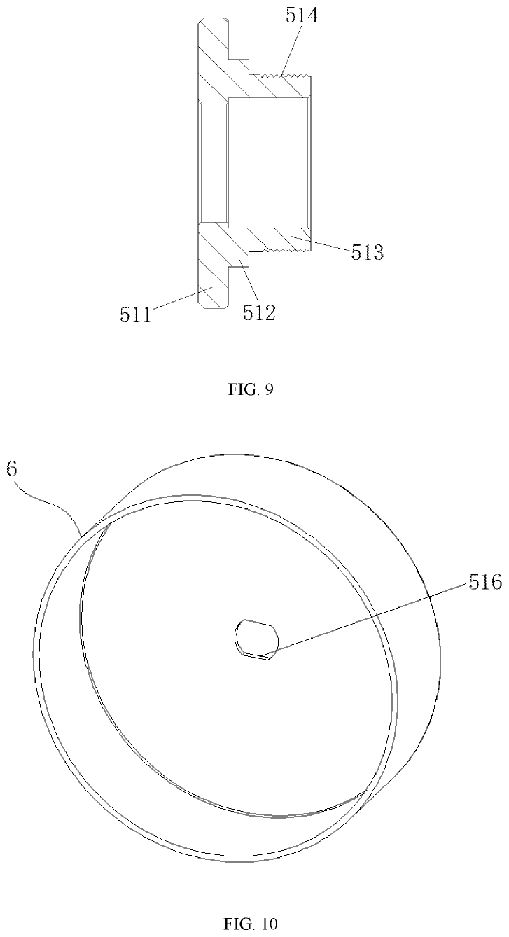

Referring to FIG. 1 to FIG. 10, an embodiment of the present invention provides a novel running wheel device for the hamster. The running wheel device includes a bottom plate 1, a height and angle adjusting mechanism 2, a mounting shaft 3, a bearing 4, a running wheel mounting assembly 5 and a running wheel body 6. The structures of respective components and their working principles will be described below.

Preferably, the height and angle adjusting mechanism 2 includes an erected mounting column 21, an adjusting sleeve 22 and at least one first locking screw 23, wherein the mounting column 21 is cylindrical, and the lower end of the mounting column 21 is fixedly connected to the bottom plate 1; the adjusting sleeve 22 rotatably and liftably sleeves the mounting column 21; a wall body of the adjusting sleeve 22 is provided with at least one transverse first screw hole 221 in a penetrating manner; and the first locking screws 23 are respectively in threaded connection into the corresponding first screw holes 221 and lock the outer wall of the mounting column 21, such that the adjusting sleeve 22 locks the mounting column 21. In other embodiments, in order to make the adjusting sleeve more stably locked on the mounting column, the number of the first locking screws can be increased according to the user's needs, which is not limited to this embodiment.

In the case that the height and angle of the running wheel body are adjusted, the user can unscrew the first locking screws, and then drive the adjusting sleeve to rotate and lift, so as to adjust the height and angle of the running wheel body. After the position is adjusted, the first locking screws are re-tightened again to complete the height and angle adjustment of the running wheel body.

In this embodiment, the outer side wall of the adjusting sleeve 22 is concavely provided with a transverse insertion hole 223; one end of the adjusting sleeve 22 is concavely provided with a longitudinal second threaded hole 225, wherein one end of the second threaded hole 225 is communicated with the insertion hole 223; the mounting shaft 3 is arranged transversely; one end of the mounting shaft 3 is inserted into the insertion hole 223 of the adjusting sleeve 22; and the second locking screw 224 is mounted in the second screw hole 225 and locks the outer wall of one end of the mounting shaft 3, such that one end of the mounting shaft 3 is fixedly inserted into the insertion hole 223.

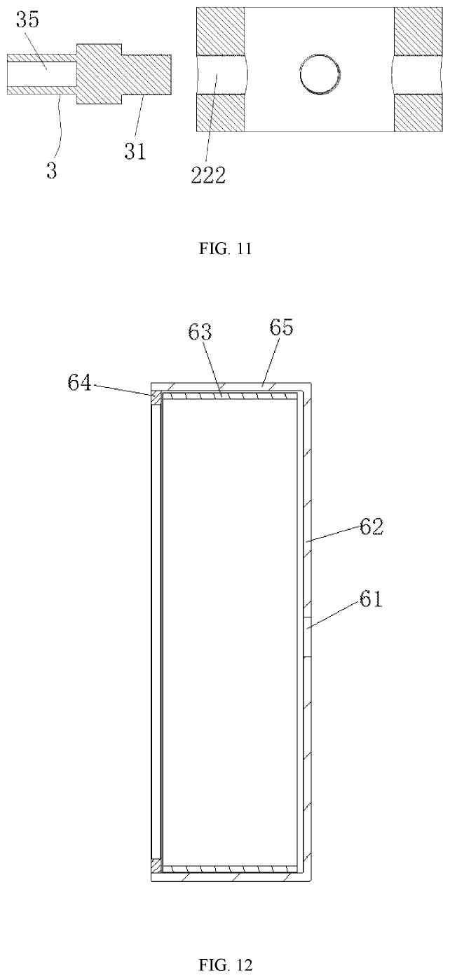

As shown in FIG. 11, in another embodiment, an outer wall of one end of the mounting shaft 3 is provided with a first outer thread 31; the outer side wall of the adjusting sleeve 22 is concavely provided with a transverse first threaded hole 222; and one end of the mounting shaft 3 is inserted into the first threaded hole 222 of the adjusting sleeve 22 and is in threaded connection to the first threaded hole 222, and thus connected to the adjusting sleeve 22. Of course, the mounting shaft can also be connected to the adjusting sleeve through other connection methods, which is not limited to this embodiment.

In this embodiment, the bearing 4 may be provided as a common ball bearing on the market, and the ball bearing is mounted at the other end of the mounting shaft 3; and an inner ring of the ball bearing and the mounting shaft 3 are fixedly connected by means of interference fit.

A limiting protrusion 36 may be convexly arranged in the middle of the mounting shaft 3, wherein one end of the limiting protrusion abuts against the outer wall of the adjusting sleeve, thereby achieving a mounting limit between the mounting shaft and the adjusting sleeve; and the other end of the limiting protrusion abuts against one of the bearings, thereby achieving a mounting limit of the bearings.

Specifically, the running wheel mounting assembly 5 includes a positioning member 51 and a locking nut 52, wherein the positioning member 51 sleeves the outer ring of the bearing 4; the positioning member 5 includes a limiting portion 511, a positioning portion 512 and a cover body connecting portion 513, wherein the limiting portion 511 is used to abut against the back surface of the running wheel body 6; the positioning portion 512 is inserted into a center hole 61 in a back plate of the running wheel body 6; the cover body connecting portion 513 is used for mounting the locking nut 52; the limiting portion 511, the positioning portion 512 and the cover body connecting portion 513 are connected in sequence; an area of the limiting portion is greater than an area of the positioning portion; the surface of one end of the cover body connecting portion 513 away from the positioning portion 512 is provided with a second outer thread 514; an inner wall of the center hole of the locking nut 52 is provided with an inner thread 521; the positioning portion 512 is inserted into the center hole 61 in the back plate of the running wheel body 6; the limiting portion 511 is located on the back of the running wheel body 6; the locking nut 52 is matched with the second outer thread 514 of the cover body connecting portion 513 through the inner thread 521, and thus mounted on the cover body connecting portion 513 and located on the inner surface of the running wheel body 6; and the locking nut 52 locks the running wheel body 6 between the limiting portion 511 and the locking nut 52.

In order to achieve the positioning between the positioning portion and the running wheel body, a positioning structure is arranged between the running wheel body 6 and the positioning portion 512 of the positioning member 51. The positioning structure is provided with two first planes 515 and two second planes 516, wherein the positioning portion 512 is circular; the two first planes 515 are symmetrically arranged on the outer side wall of the positioning portion 512; the center hole 61 in the back plate of the running wheel body 6 is provided as a circular hole; the two second planes 516 are symmetrically arranged on the inner wall of the center hole 61 in the back plate of the running wheel body 6; and the first planes 515 are respectively in contact and cooperation with the respective second planes 516.

An end cover 33 located inside the running wheel body 6 is connected to the other end of the mounting shaft 3; the inner surface of the end cover 33 is provided with a stud 34; and the stud 34 is in threaded connection into the second threaded hole 35 formed in the outer end of the mounting shaft 3. The design of the end cover can be used to block exposed parts of the bearing and running wheel mounting assembly so as to prevent the hamster from reaching a rotating part and causing injury. In addition, the end cover can also prevent the running wheel body and the bearing from loosening and falling. In addition, logos such as characters or patterns may also be provided on the end cover.

The running wheel body of the present invention is locked on the positioning member through the locking nut, such that a user can quickly assemble and disassemble the running wheel body by unscrewing or tightening the locking nut, without using any tool to unscrew or tighten the screws one by one, making disassembly and assembly more convenient.

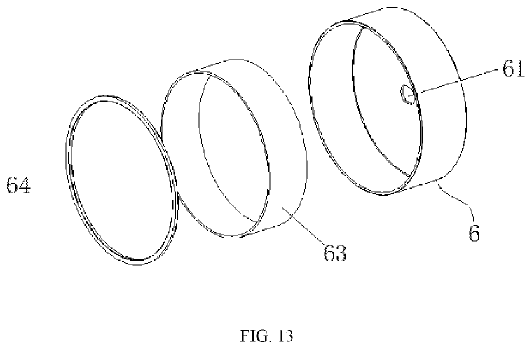

As shown in FIG. 12 and FIG. 13, the inner side wall of the running wheel body 6 is provided with an annular lining 63 for increasing a friction force between the hamster and the running wheel body 6. Preferably, the annular lining 63 may be provided as a rubber pad. Of course, in other embodiments, the annular lining may also be made of other material, as long as the friction force can be increased, which is not limited to this embodiment.

The inner edge at an entry of the running wheel body 6 is provided with an edge-biting prevention baffle ring 64 for preventing the hamster from biting the edge of the annular lining 63; and the edge-biting prevention baffle ring 64 is located on the side edge of the annular lining 63 and blocks the edge of the annular lining 63.

In this embodiment, the edge-biting prevention baffle ring and the running wheel body are arranged in a split manner, and they need to be mounted and fixed. However, in other embodiments, the edge-biting prevention baffle ring 64 may be integrally formed with the running wheel body 6.

The above-mentioned embodiments are preferred embodiments of the present invention, but the embodiments of the present invention are not limited by the above-mentioned embodiments. Any other changes, modifications, substitutions, combinations, and simplifications that do not deviate from the spirit and principle of the present invention should be equivalent replacements and are included within the protection scope of the present invention.

What is claimed is:

1. A novel running wheel device for the hamster, comprising a bottom plate, a height and angle adjusting mechanism, a mounting shaft, a bearing, a running wheel mounting assembly and a running wheel body, wherein the height and angle adjusting mechanism is mounted on the bottom plate; one end of the mounting shaft is connected to the height and angle adjusting mechanism; the mounting shaft is arranged transversely; the bearing is mounted at the other end of the mounting shaft; the running wheel body is mounted on the bearing through the running wheel mounting assembly and can rotate around the mounting shaft; and
the running wheel mounting assembly comprises a positioning member and a locking nut, wherein the positioning member sleeves an outer ring of the bearing; the positioning member comprises a limiting portion, a positioning portion and a cover body connecting portion, wherein the limiting portion is used to abut against the back surface of the running wheel body; the positioning portion is inserted into a center hole in a back plate of the running wheel body; the cover body connecting portion is used for mounting the locking nut; the limiting portion, the positioning portion and the cover body connecting portion are connected in sequence; the surface of one end of the cover body connecting portion away from the positioning portion is provided with a second outer thread; an inner wall of the center hole of the locking nut is provided with an inner thread; the positioning portion is inserted into the center hole in the back plate of the running wheel body; the limiting portion is located on the back of the running wheel body; the locking nut is matched with the second outer thread of the cover body connecting portion through the inner thread, and thus mounted on the cover body connecting portion and located on the inner surface of the running wheel body; and the locking nut locks the running wheel body between the limiting portion and the locking nut.

2. The novel running wheel device for the hamster according to claim 1, wherein the height and angle adjusting mechanism comprises an erected mounting column, an adjusting sleeve and at least one first locking screw, wherein the mounting column is cylindrical, and the lower end of the mounting column is fixedly connected to the bottom plate; the adjusting sleeve rotatably and liftably sleeves the mounting column; a wall body of the adjusting sleeve is provided with at least one transverse first screw hole in a penetrating manner; and the first locking screws are respectively in threaded connection into the corresponding first screw holes and lock the outer wall of the mounting column, such that the adjusting sleeve locks the mounting column, and one end of the mounting shaft is connected to the adjusting sleeve.

3. The novel running wheel device for the hamster according to claim 2, wherein an outer wall of one end of the mounting shaft is provided with a first outer thread; an outer side wall of the adjusting sleeve is concavely provided with a transverse first threaded hole; and one end of the mounting shaft is inserted into the first threaded hole of the adjusting sleeve and is in threaded connection to the first threaded hole, and thus connected to the adjusting sleeve.

4. The novel running wheel device for the hamster according to claim 2, further comprising a second locking screw, wherein the outer side wall of the adjusting sleeve is concavely provided with a transverse insertion hole; one end of the adjusting sleeve is concavely provided with a longitudinal second threaded hole, wherein one end of the second threaded hole is communicated with the insertion hole; one end of the mounting shaft is inserted into the insertion hole of the adjusting sleeve; and the second locking screw is mounted in the second screw hole and locks the outer wall of one end of the mounting shaft, such that one end of the mounting shaft is fixedly inserted into the insertion hole.

5. The novel running wheel device for the hamster according to claim 1, wherein the positioning portion is circular; the center hole in the back plate of the running wheel body is set to be a circular hole; and a positioning structure is arranged between the running wheel body and the positioning portion of the positioning member.

6. The novel running wheel device for the hamster according to claim 5, wherein the positioning structure is provided with two first planes and two second planes, wherein the two first planes are symmetrically arranged on the outer side wall of the positioning portion; the two second planes are symmetrically arranged on the inner wall of the center hole in the back plate of the running wheel body; and the first planes are respectively in contact and cooperation with the respective second planes.

7. The novel running wheel device for the hamster according to claim 1, wherein the bearing is provided as a ball bearing; the inner ring of the bearing and the mounting shaft are fixedly connected by means of interference fit; and a limiting protrusion is convexly arranged in the middle of the mounting shaft.

8. The novel running wheel device for the hamster according to claim 1, wherein an end cover located inside the running wheel body is connected to the other end of the mounting shaft; the inner surface of the end cover is provided with a stud; and the stud is in threaded connection into the second threaded hole formed in the other end of the mounting shaft.

9. The novel running wheel device for the hamster according to claim 1, wherein the inner side wall of the running wheel body is provided with an annular lining for increasing a friction force between the hamster and the running wheel body; the inner edge at an entry of the running wheel body is provided with an edge-biting prevention baffle ring for preventing the hamster from biting the edge of the annular lining; and the edge-biting prevention baffle ring is located on the side edge of the annular lining and covers the edge of the annular lining.

10. The novel running wheel device for the hamster according to claim 9, wherein the annular lining is provided as a rubber pad.
